(19) United States
(12) Patent Application Publication
(10) Pub. No.: US 2015/0283713 A1
(43) Pub. Date: Oct. 8, 2015

(54) UTILITY KNIFE FOR KITCHEN

(71) Applicant: JIN SU PARK, SEOUL (KR)

(72) Inventor: JIN SU PARK, SEOUL (KR)

(21) Appl. No.: 14/469,574

(22) Filed: Aug. 26, 2014

(30) Foreign Application Priority Data
Apr. 7, 2014 (KR) 10-2014-0041046

(51) Int. Cl. B26B 5/00

(52) U.S. Cl. CPC B26B 5/008

(57) ABSTRACT

Provided is a utility knife for a kitchen. The utility knife includes a main knife part including a blade for cutting a food and an auxiliary knife part including at least one auxiliary blade that is perpendicular to the main knife part, the auxiliary knife part being detachably mounted on the main knife part. The food is sliced into a predetermined size by cutting the food once.

### CROSS-REFERENCE TO RELATED APPLICATION

This application claims the priority benefit of Korean patent application serial no. 10-2014-0041046, filed on Apr. 7, 2014. The entirety of the above-mentioned patent application is hereby incorporated by reference herein and made a part of this specification.

### BACKGROUND

The present disclosure relates to a utility knife for a kitchen, and more particularly, to a utility knife for a kitchen, which has an improved structure that is capable of finely chopping a food by cutting the food once when it is intended to finely chop the food.

In general, knives for a kitchen may be kitchen utensils for cutting foods. Since such a knife for a kitchen represents a tool for cutting, if it is intended to cut a food in an octagonal shape or finely chop the food, the food has to be alternately cut several times.

### SUMMARY

The present disclosure provides a utility knife for a kitchen, which is capable of cutting a food in an octagonal shape or finely chopping the food by cutting the food once.

In accordance with an exemplary embodiment, a utility knife includes: a main knife part including a blade for cutting a food; and an auxiliary knife part including at least one auxiliary blade that is perpendicular to the main knife part, the auxiliary knife part being detachably mounted on the main knife part, wherein the food is sliced into a predetermined size by cutting the food once.

At least one coupling hole may be defined in each of one surface of the main knife part and one surface of the auxiliary knife part to screw-couple the main knife part to the auxiliary knife part, and a coupling unit may be inserted into the coupling holes of the main knife part and the auxiliary knife part to couple the main knife to the auxiliary knife.

The main knife part may have a plurality of distance adjustment holes each of which is coupled to the one auxiliary blade to adjust a distance between the auxiliary blades.

### BRIEF DESCRIPTION OF THE DRAWINGS

Exemplary embodiments can be understood in more detail from the following description taken in conjunction with the accompanying drawings, in which:

FIG. 1 is an exploded perspective view of a knife for a kitchen in accordance with an exemplary embodiment;

FIG. 2 is a perspective view of the knife for the kitchen in accordance with an exemplary embodiment;

FIG. 3 is a view of the knife for the kitchen while being used in accordance with an exemplary embodiment;

FIG. 4 is a view illustrating a modified example of an auxiliary knife part in accordance with an exemplary embodiment;

FIG. 5 is a view illustrating a modified example of the auxiliary knife part in accordance with an exemplary embodiment;

FIG. 6 is an exploded perspective view of a knife for a kitchen in accordance with another exemplary embodiment; and

FIG. 7 is a perspective view of a knife for a kitchen in accordance with still another exemplary embodiment.

### DETAILED DESCRIPTION OF EMBODIMENTS

Hereinafter, a knife for a kitchen in accordance with an embodiment will be described in detail with reference to accompanying drawings.

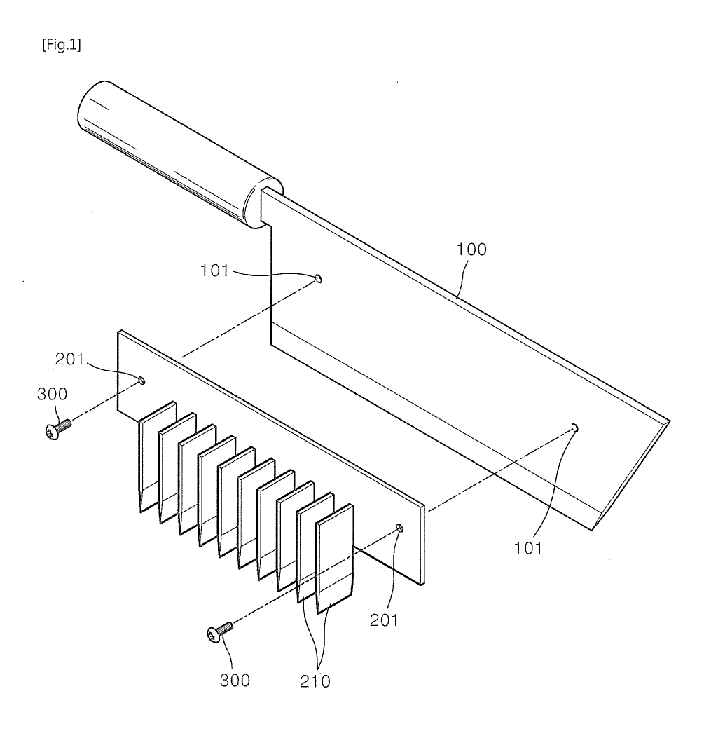

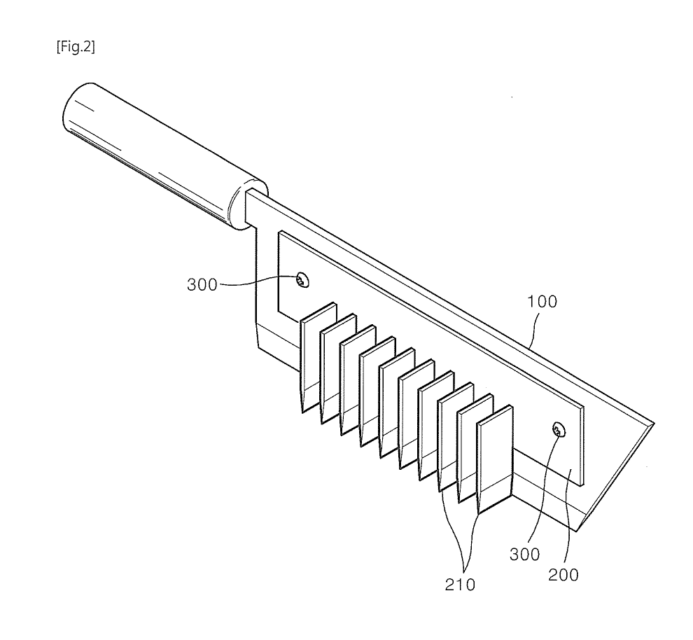

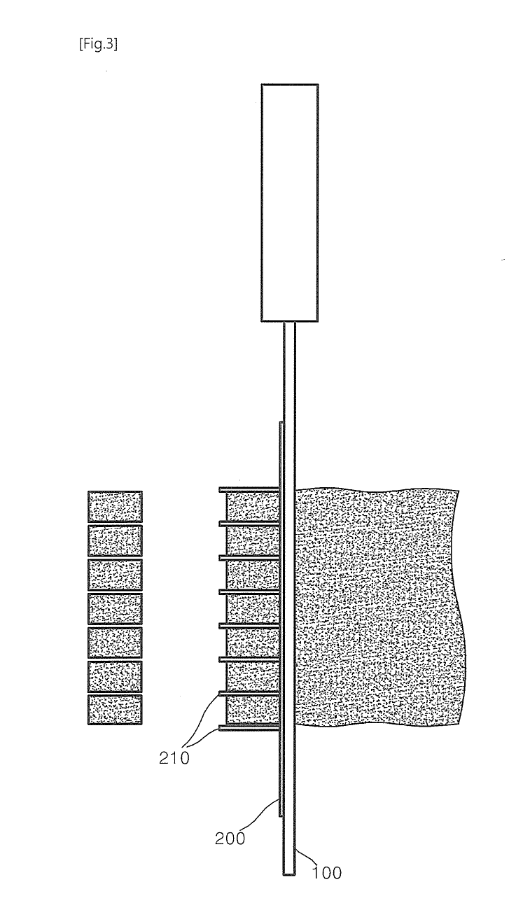

FIG. 1 is an exploded perspective view of a knife for a kitchen in accordance with an exemplary embodiment, FIG. 2 is a perspective view of the knife for the kitchen in accordance with an exemplary embodiment, and FIG. 3 is a view of the knife for the kitchen while being used in accordance with an exemplary embodiment.

As illustrated in the drawings, a knife for a kitchen in accordance with an exemplary embodiment may be used in the kitchen and includes a main knife part 100 and an auxiliary knife part 200.

The main knife part 100 includes a blade for cutting a food and a handle.

Also, the auxiliary knife part 200 includes at least one auxiliary blade 210 that is perpendicular to the main knife part 100. Here, the auxiliary knife part 200 is detachably disposed on the main knife part 100. The auxiliary knife part 200 may surface-contact one surface of the main knife part 100. Also, the plurality of auxiliary blades 210 may be soldered to one surface of the auxiliary knife part 200. Here, the auxiliary blades 210 may be perpendicular to the auxiliary knife part 200.

Thus, in accordance with an exemplary embodiment, since the auxiliary knife part 200 is mounted on the main knife part 100, a food may be sliced into a predetermined size by cutting the food once to finely chop the food.

In accordance with an exemplary embodiment, at least one coupling hole 101 may be defined in each of one surface of the main knife part 100 and one surface of the auxiliary knife part 200 to screw-couple the main knife part 100 to the auxiliary knife part 200. Here, a coupling unit 300 may be inserted into the coupling holes 101 of the main knife part 100 and the auxiliary knife part 200 to couple the main knife part 100 to the auxiliary knife part 200. The coupling unit 300 may include a screw. Thus, a screw thread to be coupled to the screw may be provided in the coupling hole 101, but the present disclosure is not limited thereto.

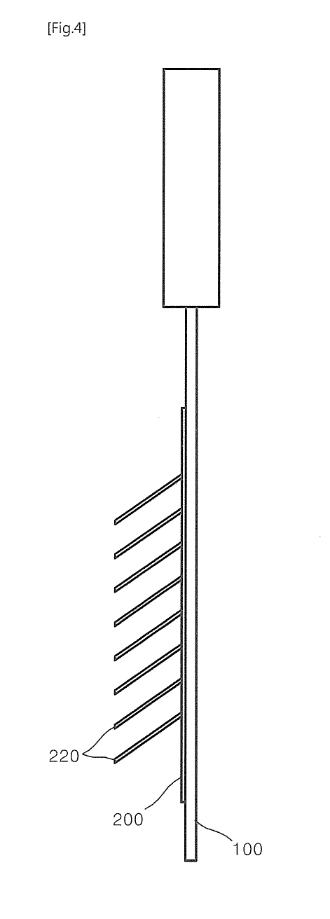

FIG. 4 is a view illustrating a modified example of the auxiliary knife part in accordance with an exemplary embodiment.

As illustrated in FIG. 4, a modified auxiliary blade 220 of the auxiliary knife part 200 in accordance with an exemplary embodiment is perpendicular to one surface of the main knife part 100. That is, the auxiliary blade 220 may make an acute or obtuse angle with the one surface of the main knife part 100. That is, the angle between the auxiliary blade 220 and the main knife part 100 may correspond to an acute or obtuse angle, unlike the foregoing embodiment.

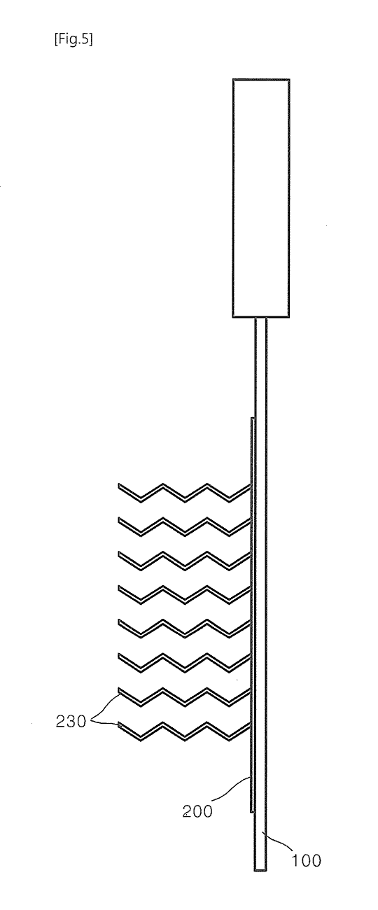

FIG. 5 is a view illustrating a modified example of the auxiliary knife part in accordance with an exemplary embodiment.

As illustrated in FIG. 5, a modified auxiliary blade 230 of the auxiliary knife part 200 in accordance with an exemplary embodiment may have various shape, unlike the forgoing embodiment.

As described above, the auxiliary blades 220 and 230 of the auxiliary knife part 200 in accordance with an exemplary embodiment may have various shapes and be angled at various angles to finely chop the food into various shapes.

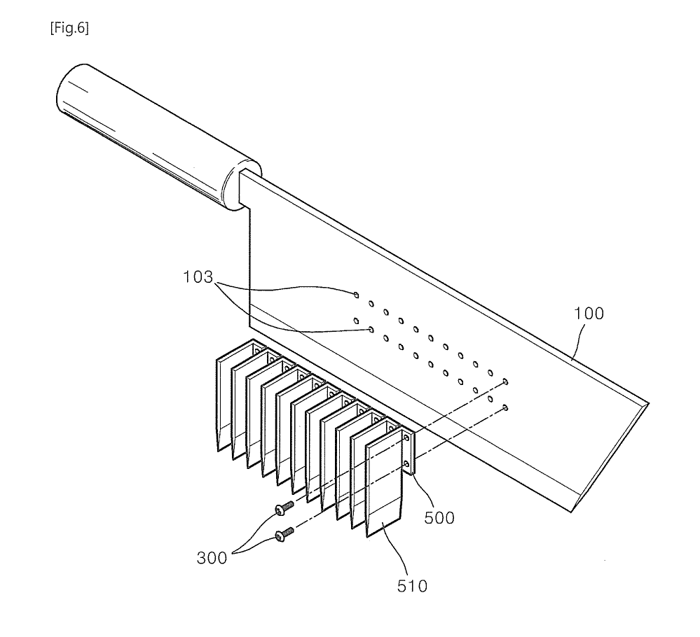

FIG. 6 is an exploded perspective view of a knife for a kitchen in accordance with another exemplary embodiment.

As illustrated in FIG. 6, unlike the foregoing embodiment, an auxiliary knife part 500 in accordance with another exemplary embodiment may be provided in plurality.

Each of the auxiliary knife parts 500 includes a support surface surface-contacting a main knife part 100 and an auxiliary blade 510 that is bent to extend from the support surface. Here, the auxiliary blade 510 may face the same direction as a blade of the main knife part 100.

Thus, the at least one auxiliary blade 500 may be coupled to the main knife part 100 in accordance with another exemplary embodiment. In addition, a plurality of distance adjustment holes 103 for adjusting a distance between the auxiliary knife parts 500 may be defined in the main knife part 100.

As described above, since the distance adjustment holes 103 are defined in the main knife part 100, a user may adjust a size of a food to be finely chopped or a position of the auxiliary knife part 500.

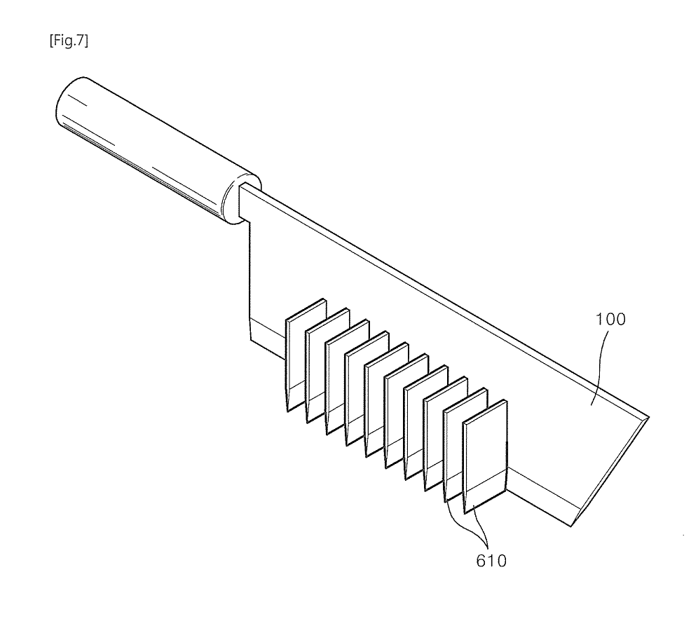

FIG. 7 is a perspective view of a knife for a kitchen in accordance with still another exemplary embodiment. As illustrated in FIG. 7, an auxiliary blade 610 in accordance with still another exemplary embodiment may be directly formed on one surface of a main knife part 110.

As described above, the knife for the kitchen in accordance with the exemplary embodiment may finely chop the food by cutting the food once. Therefore, the food may be easily finely chopped.

The present invention is not limited to the above-described embodiments and is defined by the appended claims, and also it will be apparent to those skilled in the art that various modifications and variations can be made in the present invention without departing form the spirit or scope of the invention.

What is claimed is:

1. A utility knife comprising:
a main knife part comprising a blade for cutting a food; and
an auxiliary knife part comprising at least one auxiliary blade that is perpendicular to the main knife part, the auxiliary knife part being detachably mounted on the main knife part,
wherein the food is sliced into a predetermined size by cutting the food once.

2. The utility knife of claim 1, wherein at least one coupling hole is defined in each of one surface of the main knife part and one surface of the auxiliary knife part to screw-couple the main knife part to the auxiliary knife part, and
a coupling unit is inserted into the coupling holes of the main knife part and the auxiliary knife part to couple the main knife to the auxiliary knife.

3. The utility knife of claim 1, wherein the main knife part has a plurality of distance adjustment holes each of which is coupled to the one auxiliary blade to adjust a distance between the auxiliary blades.
